(19) United States
(12) Patent Application Publication
(10) Pub. No.: US 2026/0364475 A1
(43) Pub. Date: Nov. 19, 2026

(54) INFORMATION PROCESSING DEVICE AND GAME VIDEO GENERATION METHOD

(71) Applicant: Sony Interactive Entertainment Inc., Tokyo (JP)

(72) Inventors: Nodoka Tokunaga, Tokyo (JP); Toshihiko Nagasawa, Tokyo (JP); Kiyobumi Matsunaga, Tokyo (JP); Masahiro Fujihara, Kanagawa (JP)

(73) Assignee: Sony Interactive Entertainment Inc., Tokyo (JP)

(21) Appl. No.: 19/136,337

(22) PCT Filed: Nov. 24, 2023
(86) PCT No.: PCT/JP2023/042127

§ 371 Date: Jun. 6, 2025

(30) Foreign Application Priority Data
Dec. 20, 2022 (JP) 2022-203461

(51) Int. Cl. A63F 13/85; A63F 13/215; A63F 13/49

(52) U.S. Cl. CPC A63F 13/85; A63F 13/215; A63F 13/49

(57) ABSTRACT

A recording control section 114 records in a recording section 130 game images generated according to a user operation. A video generation section 132 generates a game video including no user voice from the game images recorded in the recording section 130, according to a game video ending point designated by a user voice.

### TECHNICAL FIELD

The present disclosure relates to a technology for generating a game video that is user generated content.

### BACKGROUND ART

PTL 1 discloses an information processing device that generates game images according to a user operation and displays the generated game images on an output device, while also recording the game images in a ring buffer in the background. Users can designate a starting point and an ending point for cutting out the recorded game video on an editing screen and upload the cut-out game video to a content sharing server.

### [Cited Document] [Patent Literature]

[PTL 1] Japanese Patent Laid-open No. 2020-000870

### SUMMARY

### Technical Problem

In the past, users have conducted editing work of trimming, for example, an unnecessary user voice included in the game video or a graphical user interface (GUI) displayed superposed on the game images, before uploading the cut-out game video to the content sharing server. Such editing work is burdensome for the users, and hence caused demands for realizing a mechanism that reduces the users' trouble of editing the game video.

In view of the above circumstances, an object of the present disclosure is to realize a mechanism for efficiently generating a game video which is user generated content.

### Solution to Problem

In order to solve the problem described above, an information processing device according to a mode of the present disclosure includes one or more processors that include hardware, in which the one or more processors record, in a recording section, game images generated according to a user operation, and generate a game video that includes no user voice or user interface, from the game images recorded in the recording section, according to a game video ending point designated by a user voice or a user operation on the displayed user interface.

A game video generation method according to another mode of the present disclosure includes recording, in a recording section, game images generated according to a user operation, and generating a game video including no user voice or user interface from the game images recorded in the recording section, according to a game video ending point designated by a user voice or a user operation on the displayed user interface.

An information processing device according to a still another mode of the present disclosure includes one or more processors that include hardware, in which the one or more processors record, in a first recording section, game images generated according to a user operation, acquiring a user voice, recording the user voice in a second recording section, and generating a game video in which the game images recorded in the first recording section and the user voice recorded in the second recording section are combined.

A game video generation method according to yet another mode of the present disclosure includes recording, in a first recording section, game images generated according to a user operation, acquiring a user voice, recording the user voice in a second recording section, and generating a game video in which the game images recorded in the first recording section and the user voice recorded in the second recording section are combined.

It is to be noted that any combination of the abovementioned constituent elements and expressions of the present disclosure converted between methods, devices, systems, recording media, computer programs, and the like are also effective as modes of the present disclosure.

### BRIEF DESCRIPTION OF DRAWINGS

FIG. 1 is a view illustrating an information processing system according to an embodiment.

FIG. 2 is a view illustrating a hardware configuration of an information processing device.

FIG. 3 is a view illustrating functional blocks of the information processing device.

FIG. 4 is a view illustrating an example of a game screen.

FIG. 5 is a view illustrating character strings that are displayed superposed on the game screen.

FIG. 6 is a view illustrating a content starting point and a content ending point that are designated by a user.

FIG. 7 is a view illustrating the content starting point and the content ending point.

FIG. 8 is a view illustrating the content starting point and the content ending point that are designated by the user.

FIG. 9 is a view illustrating the content starting point and the content ending point.

FIG. 10 is a view illustrating another example of the functional blocks of the information processing device.

FIG. 11 is a view illustrating the starting point and the ending point that are designated by the user.

FIG. 12 is a view illustrating a modification of the functional blocks of the information processing device.

FIG. 13 is a view illustrating an example of a GUI that is displayed superposed on the game screen.

FIG. 14 is a view illustrating another example of the GUI that is displayed superposed on the game screen.

FIG. 15 is a view illustrating the content starting point and the content ending point.

### DESCRIPTION OF EMBODIMENT

In an embodiment processing system according to an embodiment, an information processing device executes a game program according to a user operation and displays game images on an output device, while also recording the game images in a buffer (recording section) such as a ring buffer together with time information. When a user designates a starting point and an ending point for cutting out the game images recorded in the buffer while playing a game, the information processing device cuts out a game video from the buffer, according to the starting point and the ending point designated by the user, and records the cut-out game video as user generated content (UGC) in a storage device.

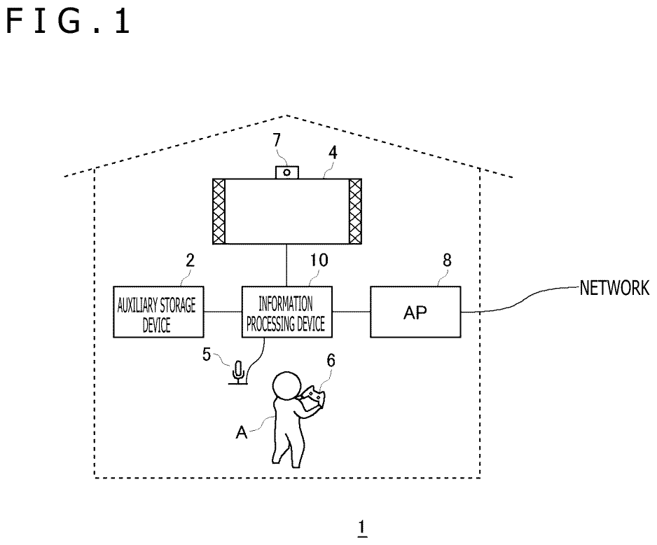

FIG. 1 illustrates an information processing system 1 according to the embodiment of the present disclosure. The information processing system 1 includes an information processing device 10 as a user terminal device, an auxiliary storage device 2, and an output device 4. An access point (hereinafter referred to as an “AP”) 8 has functions of a wireless access point and a router, and the information processing device 10 connects to the AP 8 in a wireless or wired manner, and connects to a content sharing server (not illustrated) on a network such that communication can be performed therewith.

The information processing device 10 connects, in a wireless or wired manner, to an input device 6 operated by a user A (hereinafter, sometimes simply referred to as the “user”), and the input device 6 transmits information regarding the operation performed by the user to the information processing device 10. Upon receiving the operation information from the input device 6, the information processing device 10 reflects the operation information in the processing in system software and game software and causes the output device 4 to output the processing result.

In the present embodiment, the information processing device 10 may be a game device (game console) that executes a game program, while the input device 6 may be a device that supplies information regarding an operation performed by the user to the information processing device 10, such as a game controller. Note that the input device 6 may be an input interface such as a keyboard or a mouse.

In a modification, the information processing system 1 may include a cloud game server that executes a game program according to a user operation. In this modification, the information processing device 10 transmits information regarding a game operation performed by the user to the game server. The game server generates game images and game sounds according to the user operation, and streams the game images and the game sounds to the information processing device 10. In this modification, the information processing device 10 is not required to have a function of executing game programs, and may be a terminal device that outputs the game images and the game sounds from the output device 4.

The auxiliary storage device 2 is a large-capacity storage device such as a hard disk drive (HHD) or a solid state drive (SSD) and may be a built-in storage device or an external storage device that connects with the information processing device 10 by a universal serial bus (USB), for example. The output device 4 may be a television set that includes a display device for outputting images and a speaker for outputting sounds. The output device 4 may be connected to the information processing device 10 by a wire cable or in a wireless manner.

A camera 7 that is an imaging device is provided in the vicinity of the output device 4 and images the space around the output device 4. While the camera 7 is illustrated in FIG. 1 as being attached to an upper portion of the output device 4, the camera 7 may instead be disposed on a side portion or a lower portion of the output device 4; in either case, the camera 7 is disposed at a position where the user positioned in front of the output device 4 can be imaged. The camera 7 may be a stereo camera.

A microphone 5 is disposed in the vicinity of the user and acquires a voice issued by the user. The user can upload a game live video to the content sharing server by giving a live commentary on the game he/she is playing and recording the live commentary voice together with the game images and the game sounds in a buffer (recording section). For the purpose of acquiring a clear user voice, the microphone 5 may be built in the input device 6 that is located near the user. Note that the user may give a live commentary using a headset including the microphone 5 and earphones (headphones).

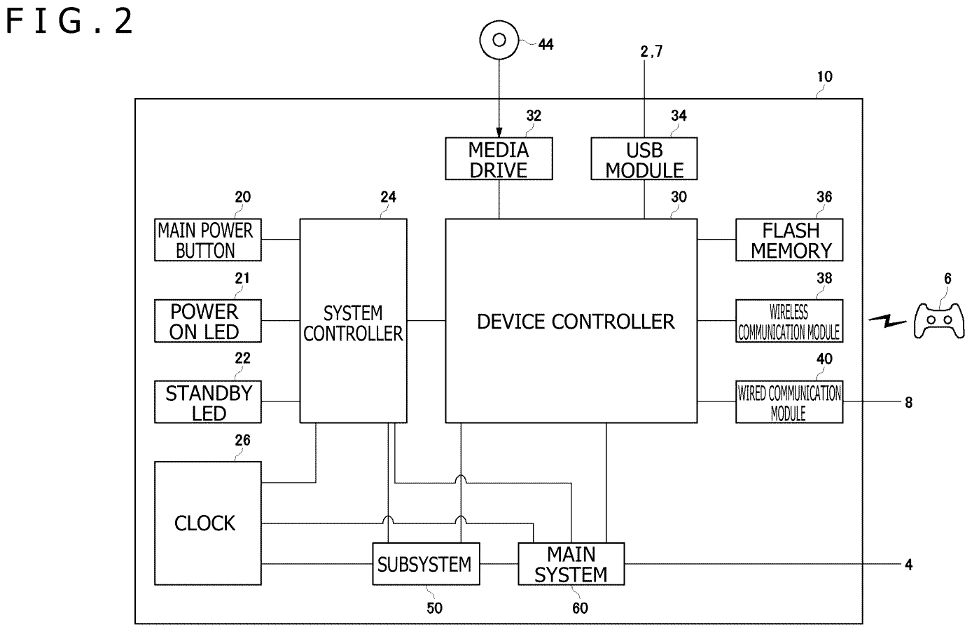

FIG. 2 illustrates a hardware configuration of the information processing device 10. The information processing device 10 includes a main power button 20, a power ON light emitting diode (LED) 21, a standby LED 22, a system controller 24, a clock 26, a device controller 30, a media drive 32, a USB module 34, a flash memory 36, a wireless communication module 38, a wired communication module 40, a subsystem 50, and a main system 60.

The main system 60 includes a main central processing unit (CPU), a memory as a main storage device, a memory controller, a graphics processing unit (GPU), and the like. The GPU is mainly used for arithmetic processing for game programs. The main CPU has a function of activating system software and executing a game program installed in the auxiliary storage device 2, under an environment provided by the system software. The subsystem 50 includes a sub-CPU, a memory as a main storage device, a memory controller, and the like, but not the GPU.

The main CPU has a function of executing the game programs installed in the auxiliary storage device 2 and a read only memory (ROM) medium 44, but the sub-CPU has no such function. Yet, the sub-CPU has a function of accessing the auxiliary storage device 2. The sub-CPU has only such a limited processing function, and can thus operate at small power consumption compared to the main CPU. These functions of the sub-CPU are executed when the main CPU is in a standby state.

The main power button 20 is an input section by which an operation input by the user is made, is provided on a front surface of a housing of the information processing device 10, and is operated to turn on or off power supply to the main system 60 of the information processing device 10. The power ON LED 21 is lit when the main power button 20 is turned on, while the standby LED 22 is lit when the main power button 20 is turned off. The system controller 24 detects that the main power button 20 is being pressed by the user.

The clock 26 is a real-time clock, generates current date and time information, and supplies the current date and time information to the system controller 24, the subsystem 50, and the main system 60.

The device controller 30 is configured as a large-scale integrated circuit (LSI) that exchanges information between devices like a southbridge. As illustrated in FIG. 2, to the device controller 30, devices including the system controller 24, the media drive 32, the USB module 34, the flash memory 36, the wireless communication module 38, the wired communication module 40, the subsystem 50, and the main system 60 are connected. The device controller 30 absorbs a difference in electric properties and a difference in data transfer speed among the devices, and controls the timing of data transfer.

The media drive 32 is a drive device that drives with the ROM medium 44, in which application software such as a game and license information are recorded, being mounted thereon, and reads programs, data, and the like from the ROM medium 44. The ROM medium 44 is a read-only recording medium such as an optical disk, a magneto-optical disk, and a Blu-ray disc.

The USB module 34 is a module that connects with an external device by a USB cable. The USB module 34 may connect with the auxiliary storage device 2 and the camera 7 by a USB cable. The flash memory 36 is an auxiliary storage device that configures internal storage. The wireless communication module 38 is a communication protocol as exemplified by a Bluetooth (registered trademark) protocol or an Institute of Electrical and Electronics Engineers (IEEE) 802.11 protocol, and performs wireless communication with the input device 6, for example. In a case where the microphone 5 is built in the input device 6, the user voice acquired by the microphone 5 is transmitted to the wireless communication module 38. The wired communication module 40 performs wired communication with an external device and connects to an external network via the AP 8, for example.

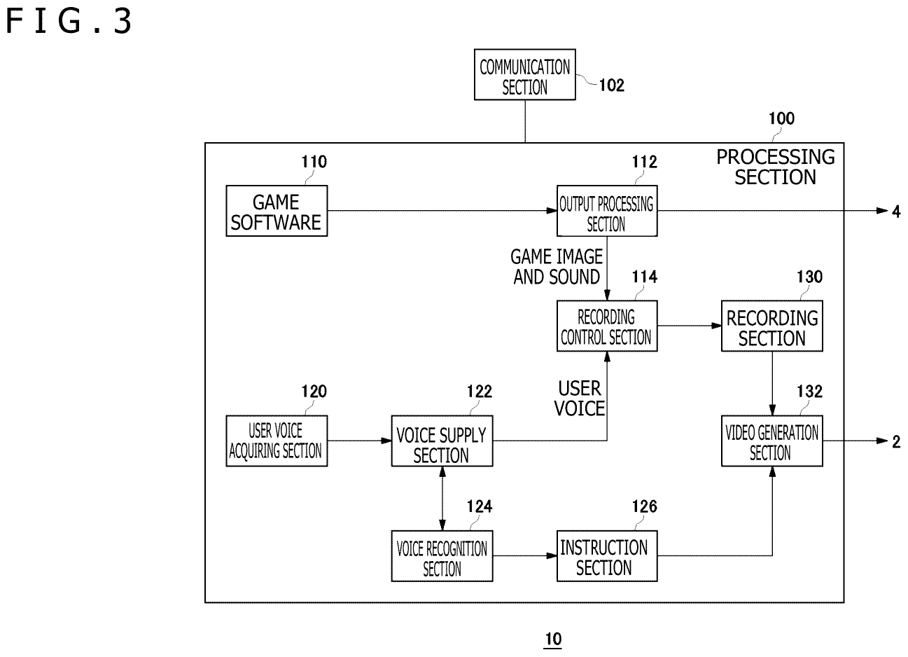

FIG. 3 illustrates functional blocks of the information processing device 10. The information processing device 10 according to the present embodiment includes a processing section 100 and a communication section 102 and has a function of temporarily recording, in the background, game images generated according to a user operation and generating a game video which is user generated content (hereinafter, sometimes simply referred to as the “content”) by using the recorded game images. The processing section 100 includes game software 110, an output processing section 112, a recording control section 114, a user voice acquiring section 120, a voice supply section 122, a voice recognition section 124, an instruction section 126, a recording section 130, and a video generation section 132.

The information processing device 10 illustrated in FIG. 3 includes a computer, which executes programs to implement various functions illustrated in FIG. 3. The computer includes, as hardware, a memory for loading programs, one or more processors for executing the loaded programs, an auxiliary storage device, other LSIs, and the like. The processor is configured by a plurality of electronic circuits including semiconductor integrated circuits and LSIs. The plurality of electronic circuits may be mounted on a single chip or a plurality of chips. A person ordinarily skilled in the art would recognize that the functional blocks illustrated in FIG. 3 are implemented by cooperation between hardware and software and hence these functional blocks can be implemented in various ways including hardware alone, software alone, and a combination of the two.

The communication section 102 has functions of both the wireless communication module 38 and the wired communication module 40. While the user is playing a game, the communication section 102 receives information regarding the operation performed by the user on the input device 6 (game operation information) and provides the information to the game software 110.

The game software 110 includes at least a game program, image data, and sound data. The game program, upon receiving information regarding the game operation performed by the user, performs arithmetic processing of moving a player character in a virtual space. The output processing section 112 generates game images and game sounds (game image and sound) according to the result of arithmetic processing performed by the game software 110 and causes the output device 4 to output the generated game images and game sounds. The output processing section 112 may include a GPU that executes rendering processing and the like.

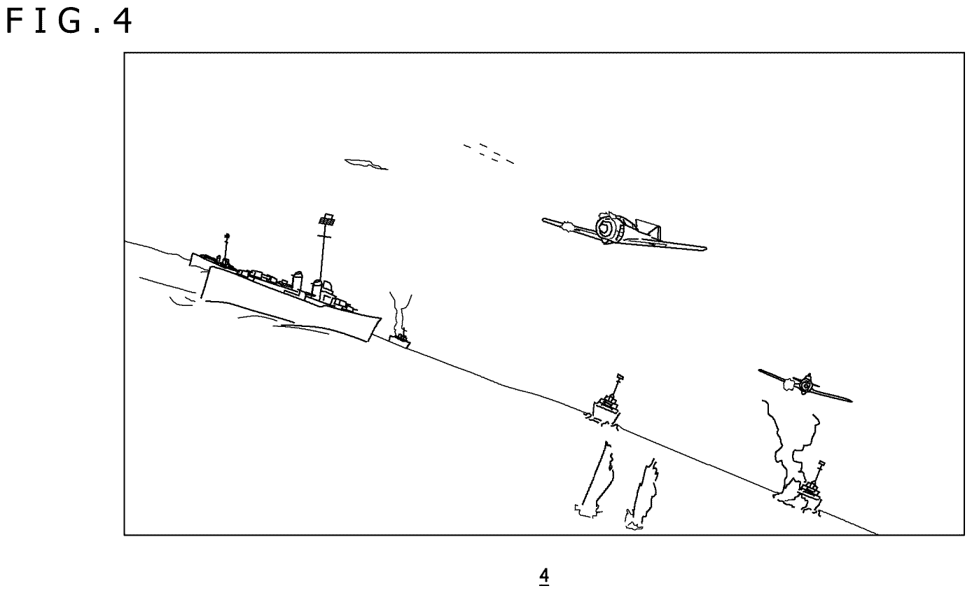

FIG. 4 illustrates an example of a game screen displayed on the output device 4. The user proceeds the game by operating the input device 6 while looking at the game images.

In the information processing device 10, the output processing section 112 causes the output device 4 to output game images and game sounds, and supplies the game images and the game sounds to the recording control section 114. The information processing device 10 has the function of recording, in the background, the game images and the game sounds that have been generated by the output processing section 112, and the recording control section 114 records the game images and the game sounds generated according to a user operation in the recording section 130. In the following description, the game images and the game sounds are sometimes simply referred to as the “game images” for the sake of description.

The recording section 130 is a buffer for temporarily retaining the game images, and may be provided in a storage area of the auxiliary storage device 2. The recording section 130 may be a ring buffer, which may be configured by setting a start address and an end address in the storage area of the auxiliary storage device 2. The start address and the end address of the ring buffer area may be set either before shipment of the information processing device 10 or freely by a user. The recording control section 114 temporarily records the game images together with time information (time stamp) in the recording section 130.

The recording control section 114 records, in real time, the game images generated according to the user operation, in the order of addresses set in advance, starting from the start address, and then overwrites the game images from the start address after completing the recording up to the end address. The recording control section 114 repeats this process. For example, the recording section 130 is set to have a capacity that allows recording of game images for a maximum of 60 minutes (one hour). The recording section 130 hence records game images of the last 60 minutes gameplay by the user.

In the present embodiment, the user gives a live commentary on a game while playing the game. When a voice issued by the user is input to the microphone 5, the user voice acquiring section 120 acquires the user voice input to the microphone 5, and the voice supply section 122 supplies the user voice to the recording control section 114. The recording control section 114 combines the game images supplied from the output processing section 112 with the user voice supplied from the voice supply section 122, and records the combined game images and user voice in the recording section 130. That is, in the recording section 130, a game video including the user's voice of giving a live commentary is recorded.

In the present embodiment, the user, while playing a game, can generate user generated content by cutting out desired scenes from the game images recorded in the recording section 130 and save the content in the auxiliary storage device 2. For example, when the user, while playing a game, designates a content ending point and a time point that is a desired amount of time prior to the ending point, the video generation section 132 can cut out the game video from the recording section 130 and save the cut-out game video as user generated content in the auxiliary storage device 2. Further, when the user, while playing a game, designates a content starting point in real time and thereafter designates the content ending point in real time, the video generation section 132 can cut out the game video from the recording section 130 and save the cut-out game video as user generated content in the auxiliary storage device 2.

In the present embodiment, the user, while playing a game, can input a content generation instruction to the information processing device 10 by issuing a predetermined command by voice. Since the user is using the input device 6 for operating a game while playing the game, allowing a content generation instruction to be input by a voice command without using the input device 6 assists smooth gameplay of the user. The voice recognition section 124 performs voice recognition on the voice acquired by the user voice acquiring section 120 and converts the voice issued by the user into character strings. Note that the voice recognition section 124 and the voice supply section 122 are illustrated in FIG. 3 as separate functional blocks, but may instead be configured as an integrated functional module.

### Voice Command 1

An example of a voice command 1 is described below.
“Hey Game Console, Capture the last 5 minutes.” The user can designate the content ending point and the content starting point that is a desired amount of time prior to the ending point, by issuing a voice command 1 with his/her voice.

This voice command 1 includes a first voice command and a second voice command following the first voice command.

### (a) First Voice Command: “Hey Game Console”

The first voice command is a voice command for activating a content generation function based on a user voice. The voice recognition section 124 performs voice recognition processing on the voice input to the microphone 5 and converts the user voice into character strings. When the command “Hey Game Console” is included in the character strings obtained by conversion, the content generation function based on a user voice is activated. When the content generation function based on a user voice is activated, the instruction section 126 becomes able to instruct the video generation section 132 to generate content, based on the character strings supplied from the voice recognition section 124.

When the content generation function based on a user voice is activated, the recording control section 114 temporarily halts the processing of combining the user voice with the game images and records only the game images in the recording section 130. At this time, the recording control section 114 may temporarily halt the combining processing of the user voice by discarding the user voice supplied from the voice supply section 122, but instead the voice supply section 122 may temporarily halt the supply of a user voice to the recording control section 114. Accordingly, the recording control section 114 does not record, in the recording section 130, the voice issued by the user after issuing the command “Hey Game Console” with his/her voice. Note that the user voice is no longer combined with the game images after the voice recognition section 124 has confirmed that the first voice command “Hey Game Console” is included in the character strings converted from the user voice, so that the user voice “Hey Game Console” would be recorded in the recording section 130.

### (b) Second Voice Command: “Capture The Last 5 Minutes”

The second voice command is a voice command for designating the starting point and the ending point for cutting out content. The voice recognition section 124 performs voice recognition processing on the voice input to the microphone 5 and converts, into character strings, the voice issued by the user after the first voice command “Hey Game Console.” In this example, the voice recognition section 124 converts the user voice into the character strings “Capture the last 5 minutes” and supplies the character strings obtained by conversion to the instruction section 126.

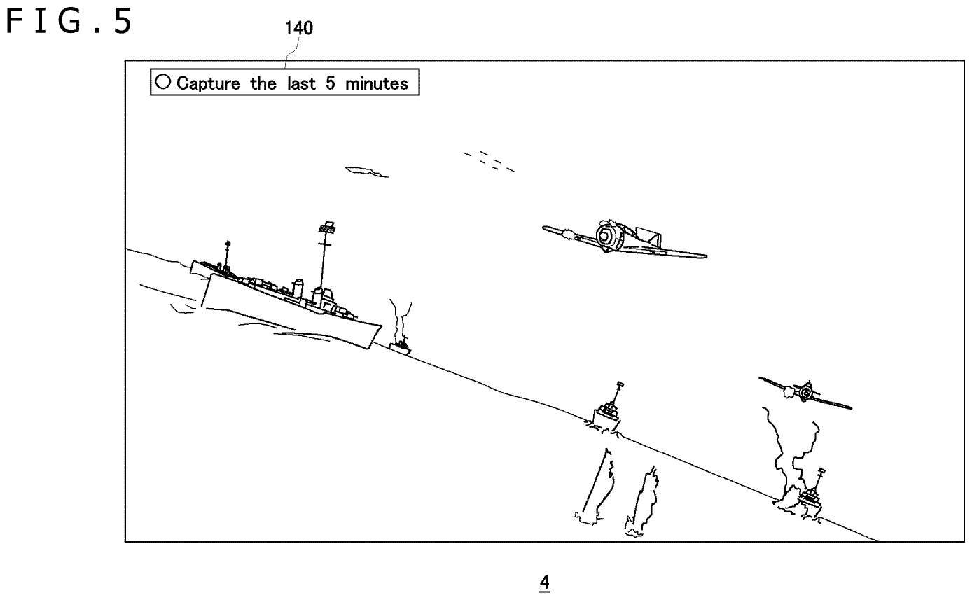

FIG. 5 illustrates the character strings that are displayed superposed on the game screen. The character strings obtained by voice recognition after the activation of the content generation function based on a user voice may be displayed superposed on the game screen displayed on the output device 4. The user, looking at character strings 140 displayed superposed on the game screen, can confirm that the content generation instruction based on a user voice has been received by the information processing device 10.

The instruction section 126, upon receiving the character strings “Capture the last 5 minutes,” recognizes that the user is requesting that the game video of the last 5 minutes be cut out. In order to increase a recognition rate of the voice command, the second voice command is preferably stylized. Specifically, since the phrase “Capture the last” is a fixed phrase, the second voice command may be established by the user voicing the length of time for cutting out the game video after issuing the phrase “Capture the last” by voice. In the present embodiment, in addition to the phrase “Capture the last,” other fixed phrases including “Save the last” and “Record gameplay for the last” may be provided to allow the user to use various kinds of second voice commands. Note that the instruction section 126 includes a natural language understanding, function and may recognize the meaning of the character strings to identify the content starting point and the content ending point that are designated by the user.

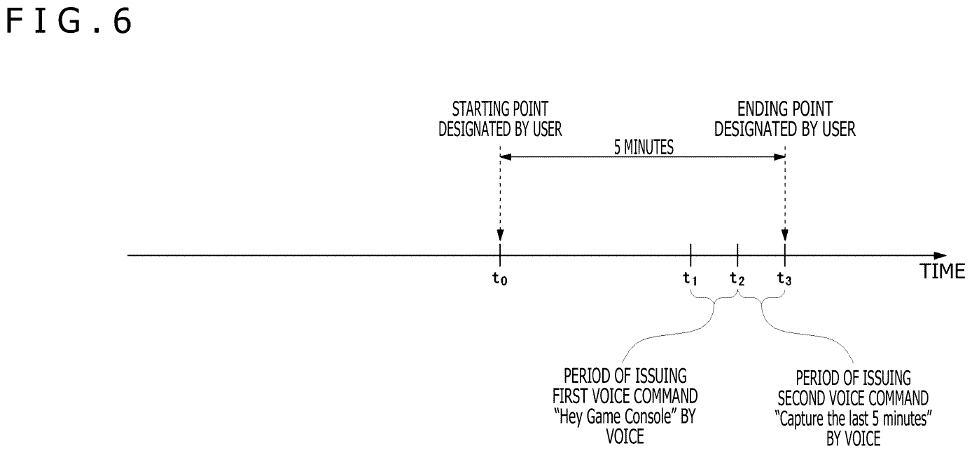

The instruction section 126, upon receiving the second voice command, identifies the ending point of the content to be generated and a content starting point that is 5 minutes prior to the ending point. In FIG. 6 below, a case where the instruction section 126 identifies, as the content ending point, the time point at which the second voice command is received, that is, the time point at which the user has completed issuing the second voice command “Capture the last 5 minutes” with his/her voice, is described.

FIG. 6 illustrates the content starting point and the content ending point that are designated by the user. Time t₁ indicates the time point at which the user started issuing the first voice command by voice, time t₂ indicates the time point at which the user completed issuing the first voice command by voice, and time t₃ indicates the time point at which the user completed issuing the second voice command by voice. The time point at which issuing of the second voice command by voice is completed can be regarded as the content ending point designated by the user. Hence, time t₃ is the content ending point designated by the user, and time t₀ which is 5 minutes prior to time t₃ is the content starting point designated by the user.

As described above, the recording control section 114 does not record, in the recording section 130, the voice issued by the user after the time point (time t₂) at which the user completed issuing the first voice command “Hey Game Consol” by voice, but the voice issuing the first voice command is recorded in the recording section 130. Hence, in the timeline illustrated in FIG. 6, the user voice “Hey Game Console” is recorded between time t₁ and time t₂, and when the game video for a period from time t₀ to time t₃ that is designated by the user is cut out, the cut-out game video includes the user voice “Hey Game Console.” In view of the abovementioned situation, the information processing device 10 according to the present embodiment has the function of generating content (game video) that includes no user voice from the game images recorded in the recording section 130, according to the content starting point and the content ending point that are designated by a user voice. The information processing device 10 assists the user in performing the content editing work, by generating content including no user voice.

### First Embodiment

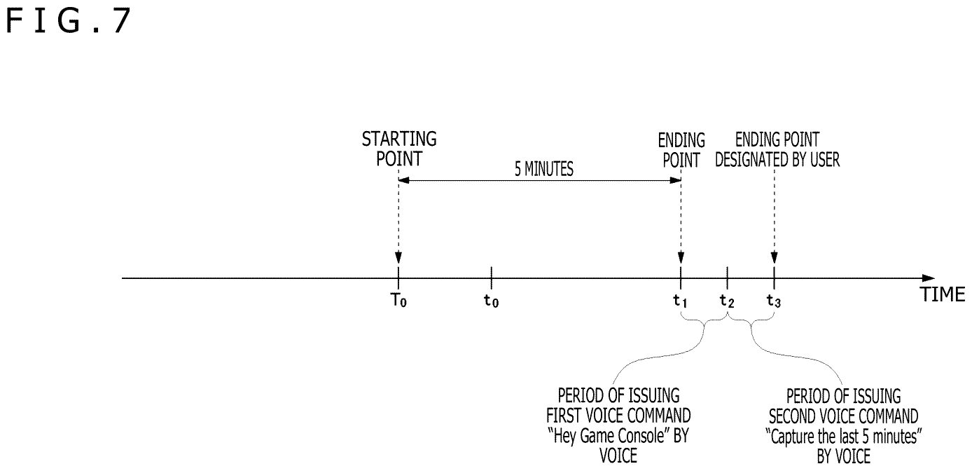

FIG. 7 illustrates the content starting point and the content ending point that are set in the first embodiment. Time t₁ indicates the time point at which the user started issuing the first voice command by voice, time t₂ indicates the time point at which the user completed issuing the first voice command by voice, and time t₃ indicates the time point at which the user completed issuing the second voice command by voice. Time t₃ is the content ending point designated by the user. Note that, for reference, time t₀ (see FIG. 6) which is the starting point designated by the user is also indicated.

In the first embodiment, the voice recognition section 124 also conveys time information regarding time t₁, time t₂, and time t₃ at the time of conveying the character strings obtained by voice recognition to the instruction section 126. Hence, the instruction section 126 recognizes the content ending point (time t₃) designated by the user and acquires the length of time of issuing the voice command 1 by the user with his/her voice (time t₃-time t₁). Note that, since the instruction section 126 is provided with the characters obtained by voice recognition from the voice recognition section 124, in units of words, the instruction section 126 may identify the time information regarding time t₁, time t₂, and time t₃ in reference to each time point at which each word is conveyed thereto.

The instruction section 126 generates a content generation instruction in which the starting point and the ending point for cutting out content are specified, and provides the content generation instruction to the video generation section 132. The video generation section 132, in accordance with the content generation instruction, cuts out from the recording section 130 a game video whose ending point is a time point that is, in terms of time, prior to the game video ending point (time t₃) designated by a user voice, and saves the cut-out game video as user generated content in the auxiliary storage device 2.

Specifically, the instruction section 126 sets the ending point to a time point that is prior to the game video ending point (time t₃) designated by a user voice, for a length of time of issuing a voice command by voice (time t₃-time t₁) or more, to set the content starting point that is 5 minutes prior to the ending point. In the example illustrated in FIG. 7, the instruction section 126 sets the ending point to a time point that is prior to the ending point (time t₃) designated by the user, for a length of time of issuing a voice command by voice (time t₃- time t₁), and sets the content starting point (To) that is 5 minutes prior to the ending point. Hence, the instruction section 126 generates the content generation instruction in which the starting point (time T₀) and the ending point (time t₁) are specified, and provides the content generation instruction to the video generation section 132. The video generation section 132, in accordance with the content generation instruction, cuts out from the recording section 130 a video game whose ending point is the time point (time t₁) that is prior to the ending point (time t₃) designated by the user, for the length of time of issuing a voice command by voice (time t₃-time t₁), and whose starting point is the time point (time T₀) 5 minutes prior to the ending point, and saves the cut-out game video as user generated content in the auxiliary storage device 2.

As described above, according to the first embodiment, in a case where the character strings converted by the voice recognition section 124 include the voice command 1, the video generation section 132 can generate a game video (content) that does not include the user voice corresponding to the voice command 1. That is, the video generation section 132 can generate content that does not include the user voice issuing the voice command, by using game images that have been recorded in the recording section 130 before the voice command 1 was issued by voice.

Note that, in the example illustrated in FIG. 7, the instruction section 126 sets the ending point to the time point (time t₁) at which the user started issuing the first voice command by voice, but for the purpose of reliably preventing the user voice from being included in the content, the ending point may be set to a time point that is a predetermined amount of time (for example, several seconds) prior to time t₁.

### Voice Command 2

Next, an example of the voice command 2 that is different from the voice command 1 is illustrated.

The voice command 2 includes the start command designating the content starting point and the end command designating the content ending point.
Start command
“Hey Game Console, Start recording”
End command
“Hey Game Console, Stop recording”

Note that the phrases “Start recording” and “Stop recording” included in the voice command 2 are not instructions related to recording in the recording section 130 but are instructions related to generation of content from the game images recorded in the recording section 130. The recording control section 114 is, at all times, recording the game images in the recording section 130, and the voice command 2 in no way affects recording of game images in the recording section 130.

The user, by issuing a start command by voice, designates the content starting point, and by issuing an end command by voice, designates the content ending point. Note that the start command and the end command are constituted as one set, and hence, unless the user issues the end command by voice after issuing the start command by voice, a game video would not be cut out from the recording section 130.

Similarly to the voice command 1, the voice command 2 includes a first voice command and a second voice command following the first voice command.

### (a) First Voice Command: “Hey Game Console”

As described above, the first voice command is a voice command for activating the content generation function based on a user voice. When the user issues the first voice command by voice, the content generation function based on a user voice is activated, and the instruction section 126 becomes able to perform the processing related to content generation, in reference to the character strings supplied from the voice recognition section 124, and the recording control section 114 temporarily halts the processing of combining the user voice and the game images.

### (b) Second Voice Command

### (b1) Start Command: “Start Recording”

This second voice command is a voice command for designating the starting point for cutting out content. The voice recognition section 124, upon acquiring the character strings “Start recording” from the voice input to the microphone 5, supplies the character strings “Start recording” to the instruction section 126 together with time information indicating the time of acquisition. Note that, when the user issues the second voice command “Start recording” by voice and the instruction section 126 receives the character strings “Start recording,” the recording control section 114 restarts the processing of combining the user voice and the game images.

### (b2) End Command: “Stop Recording”

This second voice command is a voice command for designating the ending point for cutting out content. The voice recognition section 124, upon acquiring the character strings “Stop recording” from the voice input to the microphone 5, supplies the character strings “Stop recording” to the instruction section 126 together with time information indicating the time of acquisition.

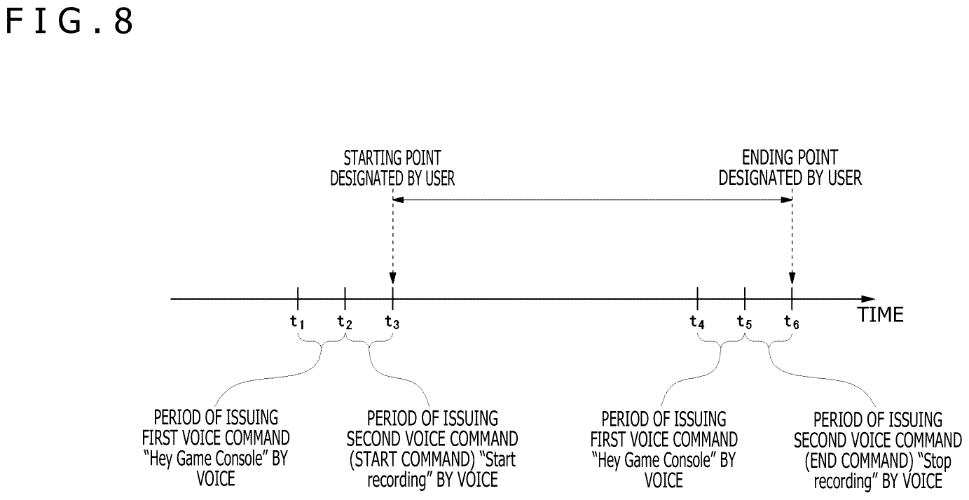

The instruction section 126, upon receiving the character strings “Stop recording” after receiving the character strings “Start recording” from the voice recognition section 124, recognizes that the user is requesting that the game video from the time point of issuing the start command “Start recording” by voice to the time point of issuing the stop command “Stop recording” by voice be cut out. The instruction section 126, upon receiving a set of a start command and an end command, identifies the starting point and the ending point of the content to be generated. In FIG. 8 described below, a case where the instruction section 126 identifies the time point of receiving the character strings “Start recording” as the content starting point and the time point of receiving the character strings “Stop recording” as the content ending point is described.

FIG. 8 illustrates the content starting point and the content ending point that are designated by the user. Time t₁ indicates the time point at which the user started issuing the first voice command by voice, time t₂ indicates the time point at which the user completed issuing the first voice command by voice, and time t₃ indicates the time point at which the user completed issuing the second voice command (start command) by voice. The time point at which issuing of the second voice command (start command) by voice is completed can be regarded as the content starting point designated by the user. Hence, time t₃ is the content starting point designated by the user.

Time t₄ indicates a time point at which the user started issuing the first voice command by voice, time t₅ indicates a time point at which the user completed issuing the first voice command by voice, and time t₆ indicates a time point at which the user completed issuing the second voice command (end command) by voice. The time point at which issuing of the second voice command (end command) by voice is completed can be regarded as the content ending point designated by the user. Hence, time t₆ is the content ending point designated by the user.

As described above, after the time point (time t₃) at which the user issued the start command “Start recording” by voice, the recording control section 114 restarts the processing of combining the game images and the user voice. In the timeline illustrated in FIG. 8, the user voice “Hey Game Console” is recorded between time t₄ and time t₅ in the recording section 130, so that, when the game video for a period from time t₃ to time t₆ designated by the user is cut out, the cut-out game video includes the user voice “Hey Game Console.”

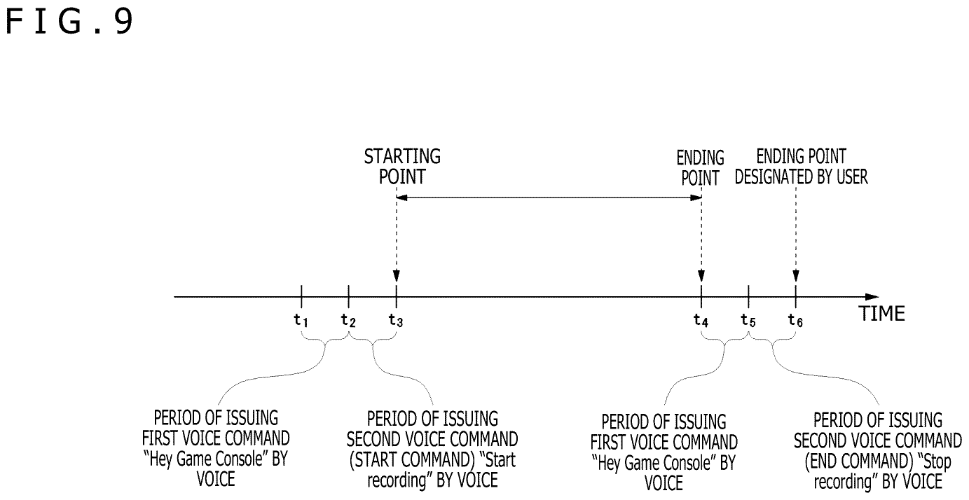

FIG. 9 illustrates the content starting point and content ending point set in the first embodiment. Time t₁ indicates the time point at which the user started issuing the first voice command by voice, time t₂ indicates the time point at which the user completed issuing the first voice command by voice, and time t₃ indicates the time point at which the user completed issuing the second voice command (start command) by voice. Time t₃ is the content starting point designated by the user.

Time t₄ indicates the time point at which the user started issuing the first voice command by voice, time t₅ indicates the time point at which the user completed issuing the first voice command by voice, and time t₆ indicates a time point at which the user completed issuing the second voice command (end command) by voice. Time t₆ is the content ending point designated by the user.

In the first embodiment, the voice recognition section 124 also conveys time information regarding time t₁, time t₂, time t₃, time t₄, time t₅, and time t₆ at the time of conveying the character strings obtained by voice recognition to the instruction section 126. £ Hence, the instruction section 126 recognizes the content ending point (time t₆) designated by the user and also acquires the length of time (time t₆-time t₄) of issuing the end command “Hey Game Console, Stop recording” by the user with his/her voice. Note that, since the instruction section 126 is provided with the characters obtained by voice recognition from the voice recognition section 124, in units of words, the instruction section 126 may identify the time information regarding time t₁, time t₂, time t₃, time t₄, time t₅, and time t₆, in reference to each time point at which each word is conveyed thereto.

The instruction section 126 generates the content generation instruction in which the starting point and the ending point for cutting out content are specified, and provides the content generation instruction to the video generation section 132. The video generation section 132, in accordance with the content generation instruction, cuts out from the recording section 130 a game video whose ending point is a time point that is, in terms of time, prior to the game video ending point (time t₆) that is designated by user voice, and saves the cut-out game video as user generated content in the auxiliary storage device 2.

Specifically, the instruction section 126 sets the ending point to a time point that is prior to the game video ending point (time t₆) designated by user voice, for the length of time of issuing the end command by voice (time t₆-time t₄) or more. The instruction section 126 may set the game video starting point (t₃) designated by a user voice as the starting point without any change. In the example illustrated in FIG. 9, the instruction section 126 sets the ending point to the time point (time t₄) that is prior to the ending point (time t₆) designated by the user, for the length of time of issuing the end command by voice (time t₆-time t₄). Thereafter, the instruction section 126 generates the content generation instruction in which the starting point (time t₃) and the ending point (time t₄) are specified, and provides the content generation instruction to the video generation section 132. The video generation section 132, in accordance with the content generation instruction, cuts out from the recording section 130 a game video whose ending point is set to the time point (time t₄) that is prior to the ending point (time t₆) designated by the user, for the length of time of issuing the end command by voice (time t₆-time t₄) and whose starting point is set to the time point (time t₃) designated by the user and saves the cut-out game video as user generated content in the auxiliary storage device 2.

As described above, according to the first embodiment, in a case where the character strings converted by the voice recognition section 124 include the voice command 2, the video generation section 132 can generate a game video (content) that does not include the user voice corresponding to the voice command 2. That is, the video generation section 132 can generate content that does not include the user voice that has issued a voice command, by using the game images that have been recorded in the recording section 130 before the end command was issued by voice.

Note that, in the example illustrated in FIG. 9, the instruction section 126 sets the ending point to the time point (time t₄) at which the user started issuing the first voice command by voice, but in order to reliably prevent any user voice from being included in the content, the ending point may be set to a time point that is a predetermined amount of time (for example, several seconds) prior to time t₄. Further, in the example illustrated in FIG. 9, the instruction section 126 sets the starting point to the time point (time t₃) at which the user completed issuing the second voice command (start command) by voice, but for the purpose of reliably preventing any user voice from being included in the content, the starting point may be set to a time point that is a predetermined amount of time (for example, several seconds) after time t₃.

### Second Embodiment

In the first embodiment, the ending point is set to a time point that is prior to the content ending point designated by the user, and the game video is cut out from the recording section 130 with use of the set ending point. In the second embodiment, the game video for a period from the content starting point to the content ending point designated by a user voice is cut out from the recording section 130, and the user voice corresponding to the voice command is removed from the cut-out game video.

Described with reference to FIG. 6, time t₀ is the content starting point designated by the user, and time t₃ is the content ending point designated by the user. In the timeline illustrated in FIG. 6, according to the second embodiment, the instruction section 126 generates the content generation instruction in which the starting point (time t₀) and the ending point (time t₃) are specified, and provides the content generation instruction to the video generation section 132. The video generation section 132 cuts out from the recording section 130 a game video whose starting point is time t₀ and whose ending point is time t₃, in accordance with the content generation instruction, and removes from the cut-out game video the user voice “Hey Game Console” recorded between time t₁ and time t₂.

In the second embodiment, the voice recognition section 124 has the function of buffering the user voice and supplies the user voice “Hey Game Console” issued by the user between time t₁ and time t₂ to the instruction section 126. When detecting that the user voice “Hey Game Console” is included in the time period between time t₁ and time t₂ by voice recognition processing, the voice recognition section 124 reads out the user voice “Hey Game Console” issued in the time period between time t₁ and time t₂ from the buffer and supplies the read user voice data to the instruction section 126 together with information regarding the length of time for which the user issued a voice (period between time t₁ and time t₂). The instruction section 126 includes the user voice “Hey Game Console” and the time information in the content generation instruction in which the starting point (time t₀) and the ending point (time t₃) are specified, and provides the resultant content generation instruction to the video generation section 132.

The video generation section 132, after cutting out a game video whose starting point is time t₀ and whose ending point is time t₃ from the recording section 130 in accordance with the content generation instruction, removes the user voice “Hey Game Console” recorded in the time period between time t₁ and time t₂, with use of the provided user voice data. Specifically, the video generation section 132 superposes the antiphase of the provided user voice on the user voice included in the game video, to cancel the user voice included in the game video and eliminate the user voice “Hey Game Console” from the game video. Note that the present embodiment is based on the specification that the user voice “Capture the last 5 minutes” following the user voice “Hey Game Console” is not recorded in the recording section 130, but in a case where the user voice “Capture the last 5 minutes” is to be also recorded in the recording section 130, the instruction section 126 provides the user voice “Hey Game Console, Capture the last 5 minutes” to the video generation section 132, and the video generation section 132 cancels the user voice “Hey Game Console, Capture the last 5 minutes” from the game video.

When nonlinear processing such as encoding processing is further applied to the user voice and the game images that are combined and recorded in the recording section 130, the video generation section 132 preferably eliminates the user voice included in the game video, by taking into consideration the nonlinear processing applied.

In this example, the video generation section 132 has been described as cancelling the voice issuing a voice command for content generation, but when the information processing device 10 allows voice commands for activating other functions, if the voice recognition section 124 detects that a user has issued a voice command by voice, with the user voice of the command being provided to the instruction section 126, the video generation section 132 is allowed to cancel the user voice of various kinds of commands from the cut-out game video.

Note that, in the abovementioned example, the video generation section 132 cancels the user voice included in the game video, by using the voice actually issued by the user. Yet, for example, the video generation section 132 may cancel the voice issuing the voice command included in the game video, by using a learned model which has learned the voice issuing the voice command. The learned model may be generated by learning the voice commands issued by various users with their voices. As described above, in a case where the information processing device 10 is allowing various kinds of voice commands for activating various kinds of functions to be received, the learned model may learn voices issuing various kinds of commands, to allow the video generation section 132 to remove the voices issuing various kinds of voice commands from the game video.

### Third Embodiment

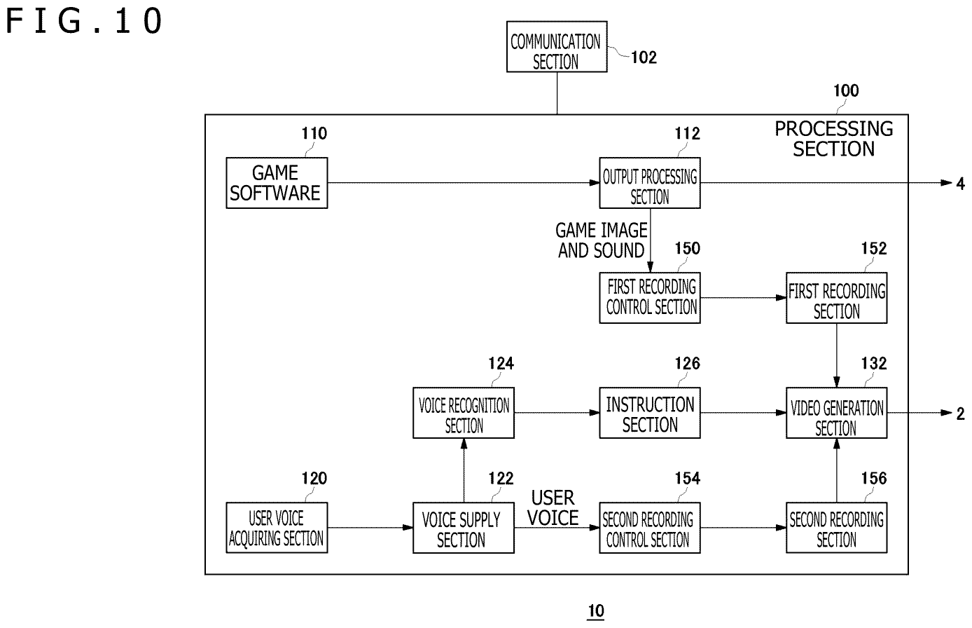

FIG. 10 illustrates another example of functional blocks of the information processing device 10. The information processing device 10 according to the third embodiment includes the processing section 100 and the communication section 102, and has a function of generating a game video which is user generated content, by temporarily recording, in the background, the game images generated according to a user operation and using the recorded game images. The processing section 100 includes the game software 110, the output processing section 112, the user voice acquiring section 120, the voice supply section 122, the voice recognition section 124, the instruction section 126, a first recording control section 150, a first recording section 152, a second recording control section 154, a second recording section 156, and the video generation section 132. The functional blocks illustrated in FIG. 10 and denoted by the same reference signs as those for the functional blocks illustrated in FIG. 3 may have the same or similar functions as those of the functional blocks illustrated in FIG. 3.

The information processing device 10 illustrated in FIG. 10 includes a computer, which executes programs to realize various functions illustrated in FIG. 10. The computer includes, as hardware, a memory for loading programs, one or more processors for executing the loaded programs, an auxiliary storage device, other LSIs, and the like. The processor is configured by a plurality of electronic circuits including semiconductor integrated circuits and LSIs, and the plurality of electronic circuits may be mounted on a single chip or a plurality of chips. A person skilled in the art would recognize that the functional blocks illustrated in FIG. 10 are implemented by cooperation between hardware and software and hence these functional blocks can be implemented in various ways including hardware alone, software alone, and a combination of the two.

The game software 110 includes at least a game program, image data, and sound data. The game program, upon receiving information regarding a game operation performed by the user, performs arithmetic processing of moving a player character in a virtual space. The output processing section 112 generates game images and game sounds according to the result of arithmetic processing performed by the game software 110 and causes the output device 4 to output the generated game images and game sounds.

In the information processing device 10, the output processing section 112 causes the output device 4 to output game images and game sounds and supplies the game images and the game sounds to the first recording control section 150. The first recording control section 150 records the game images and the game sounds generated according to the user operation in the first recording section 152. In the following description, the game images and the game sounds are sometimes simply referred to as the “game images” for the sake of description.

The first recording section 152 is a buffer for temporarily retaining game images and may be provided in a storage area of the auxiliary storage device 2. The first recording section 152 may be a ring buffer, which may be configured by setting a start address and an end address in the storage area of the auxiliary storage device 2. The start address and the end address of the ring buffer area may be set either before the shipment of the information processing device 10 or freely by the user. The first recording control section 150 temporarily records the game images together with time information (time stamp) in the first recording section 152.

The first recording control section 150 records, in real time, the game images generated according to a user operation, in the order of the addresses set in advance, starting from the start address, and then overwrites the game images from the start address after completing the recording up to the end address. The first recording control section 150 repeats this process. For example, the first recording section 152 is set to have a capacity that allows recording of game images for a maximum of 60 minutes (one hour), and hence, the game images of the user playing the game in the last 60 minutes are recorded in the first recording section 152.

The user voice acquiring section 120 acquires the user voice input to the microphone 5, and the voice supply section 122 supplies the user voice to the second recording control section 154. The second recording control section 154 records in the second recording section 156 the user voice supplied from the voice supply section 122. In the third embodiment, unlike in the first and second embodiments, the user voice is recorded in the second recording section 156 without being combined with the game video.

The second recording section 156 is a buffer for temporarily retaining a user voice and may be provided in a storage area of the auxiliary storage device 2. The storage area of the second recording section 156 is provided separately from the storage area of the first recording section 152. The second recording section 156 may be a ring buffer, which may be configured by setting a start address and an end address in the storage area of the auxiliary storage device 2. The start address and the end address of the ring buffer area may be set either before shipment of the information processing device 10 or freely by a user. The second recording control section 154 temporarily records the user voice together with time information (time stamp) in the second recording section 156.

The second recording control section 154 records, in real time, the user voice input to the microphone 5, in the order of the addresses set beforehand, starting from the start address, and overwrites the user voice from the start address after completing the recording up to the end address. The second recording control section 154 repeats this process. For example, the second recording section 156 may be set to have a capacity that allows recording of user voices for a maximum of 60 minutes (one hour).

In the third embodiment, the first recording control section 150 may at all times record game images in the first recording section 152, while the second recording control section 154 may at all times record user voices in the second recording section 156.

In the third embodiment, the user can generate user generated content by combining the game images recorded in the first recording section 152 with the user voice recorded in the second recording section 156, and save the user generated content in the auxiliary storage device 2. For example, when the user designates the content starting point and content ending point by a voice command while playing a game, the video generation section 132 cuts out the game images from the designated starting point to the designated ending point from the first recording section 152 and also cuts out the user voice from the designated starting point to the designated ending point from the second recording section 156. Then, the video generation section 132 may generate a game video by combining the game images with the user voice such that their time stamps math each other, and save the generated game video as user generated content in the auxiliary storage device 2.

In the following description, processing to be performed when the user issues the first voice command “Hey Game Console, Capture the last 5 minutes” by voice while playing a game will be described. In the third embodiment, the voice recognition section 124 converts the user voice into character strings and detects whether or not the character strings obtained by conversion include the voice command. When the character strings obtained by conversion include the voice command, the video generation section 132 generates a game video that does not include a user voice corresponding to the voice command.

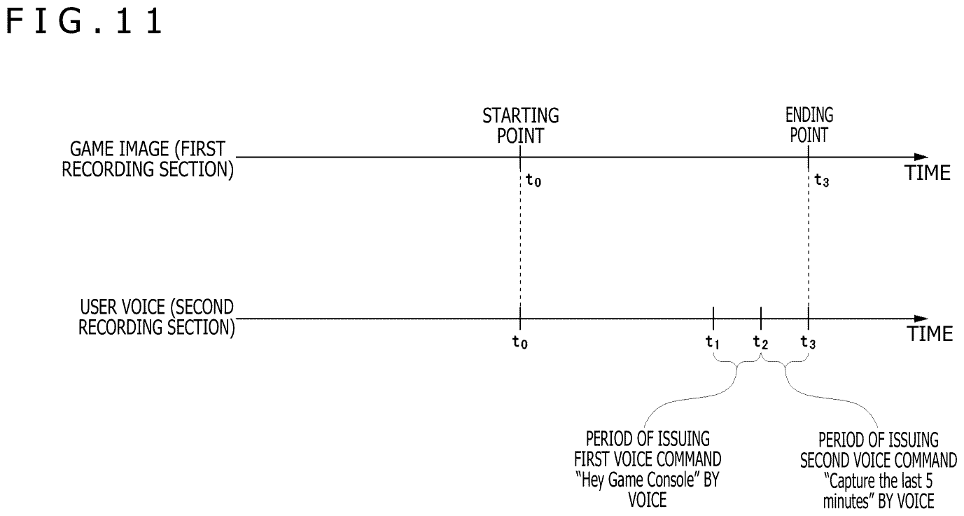

FIG. 11 illustrates the starting point and the ending point that are designated by the user with use of the first voice command in the third embodiment.

The voice recognition section 124 performs voice recognition processing on the voice input to the microphone 5 and converts the user voice into character strings. When the character strings obtained by conversion include “Hey Game Console,” the voice recognition section 124 activates the content generation function based on a user voice. When the content generation function based on a user voice is activated, the instruction section 126 becomes able to instruct the video generation section 132 to generate content, based on the character strings supplied from the voice recognition section 124.

The voice recognition section 124 performs voice recognition processing on the voice input to the microphone 5 and converts the voice issued by the user after “Hey Game Console” into character strings. In this example, the voice recognition section 124 converts the user voice into the character strings “Capture the last 5 minutes,” and supplies the character strings obtained by conversion to the instruction section 126.

The instruction section 126, upon receiving the character strings “Capture the last 5 minutes,” recognizes that the user is requesting that the game video of the last 5 minutes be cut out. The instruction section 126, upon receiving a second voice command, identifies the ending point of the content to be generated and the content starting point which is: 5 minutes prior to the ending point. In the timeline illustrated in FIG. 11, the time point at which the instruction section 126 received the second voice command, i.e., the time point at which the user completed issuing the second voice command “Capture the last 5 minutes” by voice, is identified as the content ending point.

In FIG. 11, time t₁ indicates the time point at which the user started issuing the first voice command by voice, time t₂ indicates the time point at which the user completed issuing the first voice command by voice, and time t₃ indicates the time point at which the user completed issuing the second voice command by voice. The time point at which the user completed issuing the second voice command by voice can be regarded as the content ending point designated by the user, and hence, time t₃ is the content ending point designated by the user, and time t₀ which is 5 minutes prior to time t₂ is the content starting point designated by the user.

In the third embodiment, the voice recognition section 124 also conveys the time information regarding time t₁, time t₂, and time t₃ at the time of conveying the character strings obtained by voice recognition to the instruction section 126. Thus, the instruction section 126 recognizes the content ending point (time t₃) designated by the user and the content starting point (time t₀) designated by the user. Note that, since the instruction section 126 receives the characters obtained by voice recognition from the voice recognition section 124, in units of words, the instruction section 126 may specify the time information regarding time t₁, time t₂, and time t₃, in reference to each time point at which each word is conveyed thereto. The instruction section 126 generates a content generation instruction in which the starting point (time t₀) and the ending point (time t₃) for cutting out content are specified. In the third embodiment, the instruction section 126 provides to the video generation section 132 the content generation instruction including the time information indicating the length of time for which the user has issued a voice command by voice (the period between time t₁ and time t₃).

The video generation section 132 extracts from the first recording section 152 the game images from the starting point (time t₀) to the ending point (time t₃), in accordance with the content generation instruction. Further, the video generation section 132 extracts from the second recording section 156 the user voices issued from time t₀ to time t₁ that is a time period obtained by excluding the time period between time t₁ and time t₃ which is a command issuing period from the time period between the starting point (time t₀) and the ending point (time t₃). The video generation section 132 combines the extracted game images with the extracted user voices such that the time stamps of the game images and the time stamps of the user voices match each other, to generate a game video, and saves the generated game video in the auxiliary storage device 2. In this case, the generated game video does not include the user voices issued between time t₁ and time t₃.

In the third embodiment, buffering the game images and user voices separately and not combining the game images with the user voices corresponding to voice commands in the combining process for game images and user voices makes it possible to prevent the voices issuing the voice commands from being included in the game video to be generated.

Note that, in the third embodiment, preventing the voices issuing the voice commands from being included in the game video to be generated has been described, but, for example, preventing any inappropriate issued voice from being included in the game video is also possible. That is, in the third embodiment, when the voice recognition section 124 converts the user voice into character strings and the character strings obtained by conversion include a voice command or predetermined inappropriate character strings, the video generation section 132 does not combine the game images with the user voice corresponding to the predetermined character strings, making it less troublesome for the user to trim the user voice.

The present disclosure has been described above based on the embodiments. The embodiments are mere example; persons skilled in the art should understand that a combination of the constituent elements and processes can be modified in various forms and such modifications also fall within the scope of the present disclosure.

In the embodiments, the information processing device 10 generates a game video according to a voice command, but in a modification, the information processing device 10 generates a game video according to a user operation performed on a GUI that is generated by system software.

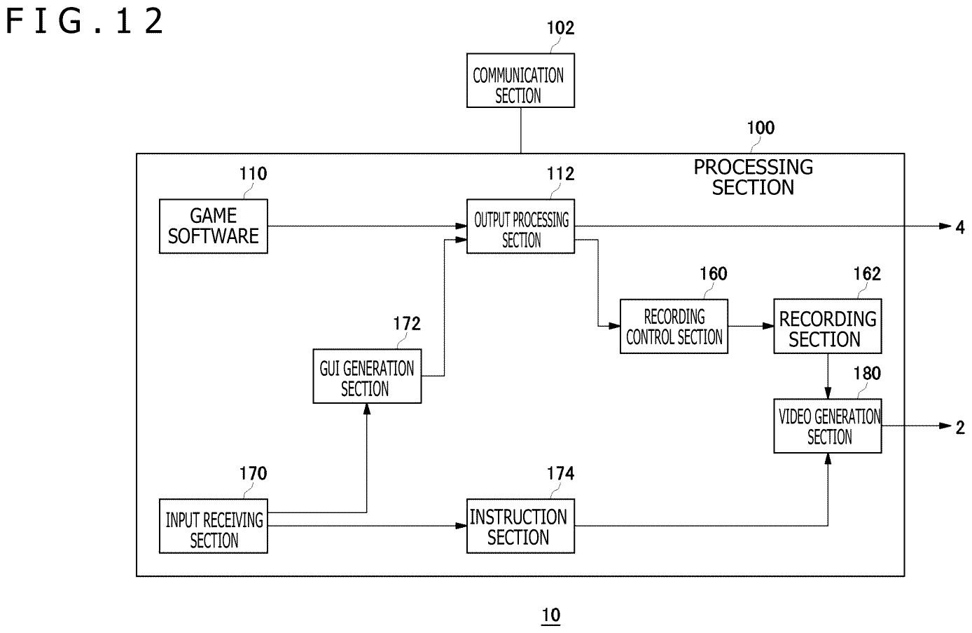

FIG. 12 illustrates a modification of the functional blocks of the information processing device 10. The information processing device 10 according to the modification includes the processing section 100 and the communication section 102 and has the function of generating a game video which is user generated content, by temporarily recording, in the background, game images generated according to a user operation and using the recorded game images. The processing section 100 includes the game software 110, the output processing section 112, a recording control section 160, a recording section 162, an input receiving section 170, a GUI generation section 172, an instruction section 174, and a video generation section 180. The functional blocks illustrated in FIG. 12 and denoted by the same reference signs as those for the functional blocks illustrated in FIG. 3 may have the same or similar functions as those of the functional blocks illustrated in FIG. 3.

The information processing device 10 illustrated in FIG. 12 includes a computer, which executes programs to implement various functions illustrated in FIG. 12. The computer includes, as hardware, a memory for loading programs, one or more processors for executing the loaded programs, an auxiliary storage device, other LSIs, and the like. The processor is configured by a plurality of electronic circuits including semiconductor integrated circuits and LSIs, and the plurality of electronic circuits may be mounted on a single chip or a plurality of chips. A person skilled in the art would recognize that the functional blocks illustrated in FIG. 12 are implemented by cooperation between hardware and software and hence these functional blocks can be implemented in various ways including hardware alone, software alone, and a combination of the two.

The game software 110 includes at least a game program, image data, and voice data. The game program, upon receiving information regarding a game operation performed by the user, performs arithmetic processing of moving a player character in a virtual space. The output processing section 112 generates game images and game sounds (game image and sound) according to the result of arithmetic processing performed by the game software 110 and causes the output device 4 to output the generated game images and game sounds.

The output processing section 112 causes the output device 4 to output game images and game sounds and supplies the game images and the game sounds to the recording control section 160. The recording control section 160 records in the recording section 162 the game images and the game sounds generated according to the user operation. In the following description, the game images and the game sounds are sometimes simply referred to as the “game images” for the convenience of description.

The recording section 162 is a buffer for temporarily retaining the game images and may be a ring buffer provided in the storage area of the auxiliary storage device 2. The recording control section 160 temporarily records in the recording section 162 game images together with time information (time stamp). The recording section 162 may have the same configuration as that of the recording section 130 illustrated in FIG. 3.

In the modification, the user operates a predetermined button (for example, the create button) of the input device 6 while playing a game, and causes the output device 4 to display a GUI for generating user generated content (video clip). When the input receiving section 170 receives an operation on a predetermined button, the GUI generation section 172 generates the GUI, and the output processing section 112 displays the GUI superposed on the game screen.

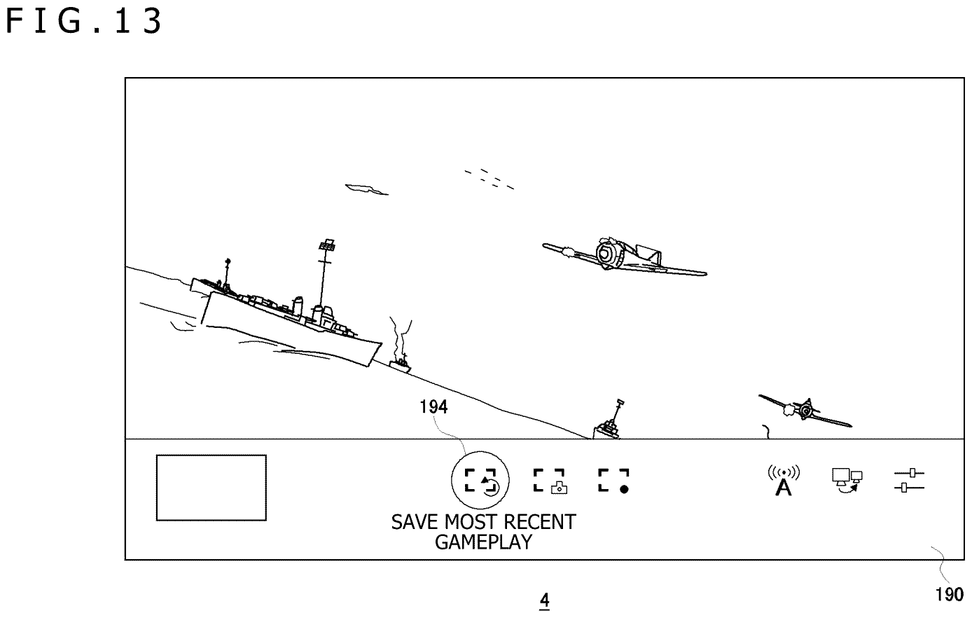

FIG. 13 illustrates an example of a GUI 190 that is displayed superposed on the game screen. The GUI 190 includes a plurality of menu items related to capturing and sharing of game images. The user selects a menu item by operating the input device 6 and moving a selection frame 194 to the position of the desired menu item. In the example illustrated in FIG. 13, the selection frame 194 is disposed on the menu item to “save most recent gameplay.” When the user operates the select button of the input device 6 in this state, the GUI generation section 172 generates the GUI for selecting the capturing time, and the output processing section 112 displays the GUI superposed on the game screen.

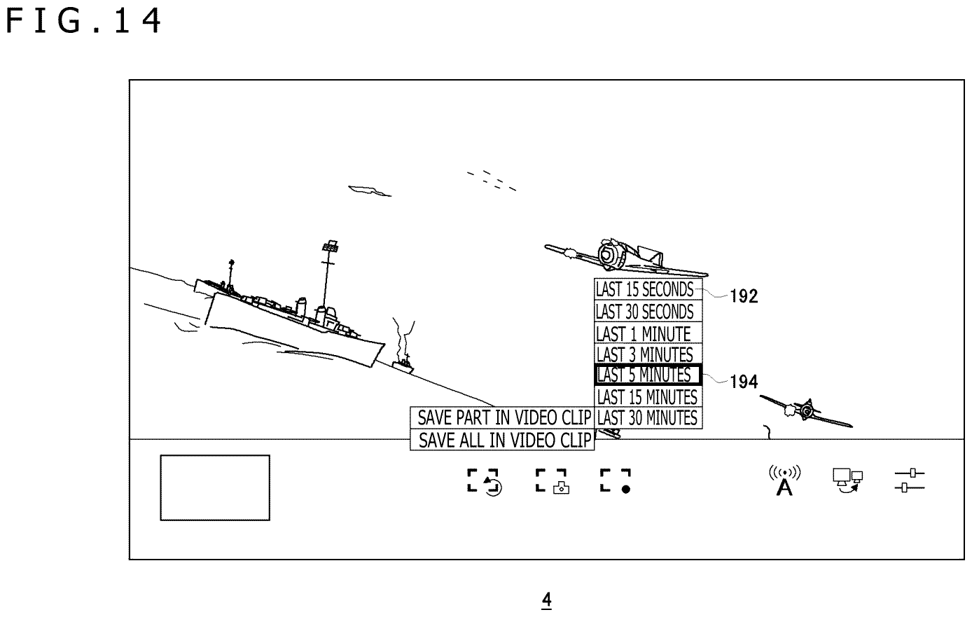

FIG. 14 illustrates an example of a GUI 192 that is displayed superposed on the game screen. The GUI 192 includes a plurality of menu items related to the time of the video clips (user generated content) to be saved. The user selects the capturing time of the game video by operating the input device 6 and moving the selection frame 194 to a position of the desired menu item. In the example illustrated in FIG. 14, the selection frame 194 is disposed on the menu item for saving the game images of the “last 5 minutes.” When the user operates the select button of the input device 6 in this state, the input receiving section 170 receives that the “last 5 minutes” has been selected, and the GUI generation section 172 ends the display of the GUI.

Upon receiving an operation on a predetermined button (create button) while the game is being played, the input receiving section 170 provides time information indicating the time when display of the GUI is started to the instruction section 174. Moreover, upon receiving an operation of selecting the capturing time of the game video on the GUI 192, the input receiving section 170 provides the selected capturing time (the last 5 minutes in this example) and the time information indicating the time when the display of the GUI is ended to the instruction section 174.

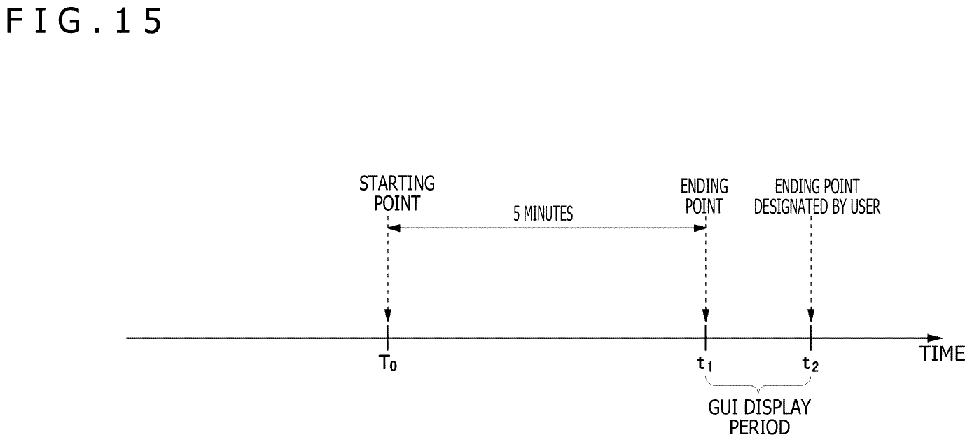

FIG. 15 illustrates a content starting point and a content ending point in a modification. Time t₁ indicates the time point at which the display of the GUI is started, and time t₂ indicates the time point at which the capturing time of the game video is selected and the display of the GUI is ended. The time point at which the capturing time of the game video is selected can be regarded as the content ending point designated by the user, and hence, time t₂ is the content ending point designated by the user.

In the modification, the instruction section 174 sets the ending point to a time point that is prior to the game video ending point (time t₂) designated by a user operation on the GUI, for the length of display time of the GUI (time t₂-time t₁) or more, to set the content starting point that is 5 minutes prior to the ending point. In the example illustrated in FIG. 15, the instruction section 174 sets the ending point to the time point (time t₁) that is prior to the ending point (time t₂) designated by the user, for the length of display time of the GUI (time t₂-time t₁), and sets the content starting point (time T₀) that is 5 minutes prior to the ending point. Following this, the instruction section 174 generates the content generation instruction in which the starting point (time T₀) and the ending point (time t₁) are specified, and provides the content generation instruction to the video generation section 180. The video generation section 180, in accordance with the content generation instruction, cuts out from the recording section 162 a game video whose ending point is the time point that is prior to the ending point (time t₂) designated by the user, for the length of display time of the GUI (time t₂-time t₁), and whose starting point is the time point (T₀) that is 5 minutes prior to the ending point, and saves the cut-out game video as user generated content in the auxiliary storage device 2.

As described above, according to the modification, if a GUI generated by system software is included in the game images recorded in the recording section 162, the video generation section 180 can generate a game video (content) that does not include the GUI. That is, the video generation section 180 can generate content including no GUI by using the game images that have been recorded in the recording section 162 before the display of the GUI.

Note that, in the example illustrated in FIG. 15, the instruction section 174 sets the ending point to the time point (time t₁) at which the display of the GUI is started, but in order to reliably prevent the GUI from being included in the content, the ending point may be set to a time point that is a predetermined amount of time (for example, several seconds) prior to time t₁.

In the embodiments and the modification, the functions of the constituent elements of the information processing device may be implemented in a circuitry or a processing circuitry that is configured to or programmed to implement the functions described in the specification, including a general purpose processor, a specific-use processor, an integrated circuit, application specific integrated circuits (ASICS), a CPU, a conventional circuit, and/or a combination of them. The processor includes a transistor and other circuits and is regarded as a circuitry or a processing circuitry. The processor may be a programmed processor that executes the programs stored in the memory.

In the present specification, a circuitry, a unit, and means are hardware that is programmed to realize the described functions or hardware that executes the functions. The hardware may be any hardware disclosed in the present specification or any hardware known as being programmed to realize the described functions or as one that executes the described functions.

When the hardware is a processor deemed to be of a circuitry type, the circuitry, the means, or the unit is a combination of hardware and software that is used to configure the hardware or the processor.

### INDUSTRIAL APPLICABILITY

The present disclosure can be used for a technology of generating a game video.

### REFERENCE SIGNS LIST

1: Information processing system
5: Microphone
6: Input device
10: Information processing device
100: Processing section
102: Communication section
110: Game software
112: Output processing section
114: Recording control section
120: User voice acquiring section
122: Voice supply section
124: Voice recognition section
126: Instruction section
130: Recording section
132: Video generation section
140: Character strings
150: First recording control section
152: First recording section
154: Second recording control section
156: Second recording section
160: Recording control section
162: Recording section
170: Input receiving section
172: GUI generation section
174: Instruction section
180: Video generation section

1. An information processing device comprising:
one or more processors that include hardware, wherein the one or more processors:
record, in a recording section, game images generated according to a user operation; and
generate a game video that includes no user voice or user interface, from the game images recorded in the recording section, according to a game video ending point designated by a user voice or a user operation on a displayed user interface.

2. The information processing device according to claim 1, wherein the one or more processors:
acquire a user voice;
combine the game images with the user voice and record the combined game images and user voice in the recording section;
convert the user voice into character strings; and
generate a game video that does not include the user voice corresponding to a voice command, when the voice command is included in the character strings obtained by conversion.

3. The information processing device according to claim 2, wherein the one or more processors:
cut out from the recording section a game video whose ending point is a time point that is before a game video ending point designated by the user voice.

4. The information processing device according to claim 3, wherein the one or more processors:
acquire a length of time of issuing a voice command by a user by voice; and
cut out from the recording section a game video whose ending point is set to a time point that is prior to the game video ending point designated by the user voice, for the length of time of issuing the voice command by voice or more.

5. The information processing device according to claim 2, wherein the one or more processors:
cut out from the recording section a game video up to the ending point designated by the user voice; and
remove the user voice corresponding to the voice command from the game video.

6. The information processing device according to claim 1, wherein the one or more processors:
cut out from the recording section a game video whose ending point is set to a time point that is prior to the game video ending point designated by the user operation on the displayed user interface.

7. The information processing device according to claim 6, wherein the one or more processors:
acquire a length of display time for which the user interface has been displayed; and
cut out from the recording section a game video whose ending point is set to a time point that is prior to the game video ending point designated by the user operation, for the length of display time or more.

8. A game video generation method for generating a game video, comprising:
recording in a recording section game images generated according to a user operation; and
generating a game video including no user voice or user interface from the game images recorded in the recording section, according to a game video ending point designated by a user voice or a user operation on a displayed user interface.

9. An information processing device comprising:
one or more processors that include hardware, wherein the one or more processors:
record in a first recording section game images generated according to a user operation;
acquiring a user voice;
recording the user voice in a second recording section; and
generating a game video in which the game images recorded in the first recording section and the user voice recorded in the second recording section are combined.

10. The information processing device according to claim 9, wherein the one or more processors:
convert the user voice into character strings; and
generate a game video that does not include the user voice corresponding to predetermined character strings, when the predetermined character strings are included in the character strings obtained by conversion.

11. The information processing device according to claim 10, wherein
the one or more processors do not combine the user voice corresponding to the predetermined character strings with the game images when the predetermined character strings are included in the character strings obtained by conversion.

12. A game video generation method for generating a game video, comprising:
recording in a first recording section game images generated according to a user operation;
acquiring a user voice;
recording the user voice in a second recording section; and
generating a game video in which the game images recorded in the first recording section and the user voice recorded in the second recording section are combined.
